(19) United States
(12) Patent Application Publication
(10) Pub. No.: US 2002/0175987 A1
(43) Pub. Date: Nov. 28, 2002

(54) Thermal printer closing apparatus

(75) Inventor: Alberto Campanini, Fidenza (IT)

Correspondence Address: LACKENBACH SIEGEL, ONE CHASE ROAD, SCARSDALE, NY, 10583, US

(73) Assignee: Custom Engineering Spa, Fontevivo (IT)

(21) Appl. No.: 10/147,174

(22) Filed: May 8, 2002

(30) Foreign Application Priority Data
May 22, 2001 (IT) EP 01830329

(51) Int. Cl. B41J 29/13

(52) U.S. Cl. 347/108

(57) ABSTRACT

A closing apparatus for a thermal printer having a fixed chassis portion and a closable cover supporting on the inside thereof a paper drive roll fixed inside of the cover for positioning itself, when the printer is closed, in a seat associated with the chassis portion and having a bottom with a level wall for locking the paper drive roll and the seat together for locking the chassis and cover together in their closed condition for preventing the paper drive roll from getting out in case of accidental pushes and consequently prevents the cover from opening, and the paper drive roll and a thermal printing head cooperate to hold the paper between the paper drive roll and the thermal printing head while the cover is closed.

### BACKGROUND OF THE INVENTION

The invention is concerned with a closing apparatus for a thermal pnnter. More particularly, this invention is concerned with the prevention of damage to the thermal printer due to an accidental opening of a cover, a falling of the printer or movements due to random vibrations.

Thermal printers generally include a fixed chassis portion and a cover associated with the chassis so that the cover and chassis together can enclose the printer. The fixed chassis portion is provided with all the printing devices, and fixed in its inside is a paper drive roll. A cover is provided to cover the various parts and with the chassis together provide for a complete closure.

In the printing art, these are known as apparatuses in connection with the closing method of the cover but up to the present there is no known solution to the problem of avoiding damage when the cover is opened and damage is caused.

### BRIEF SUMMARY OF THE INVENTION

The closing apparatus according to the invention permits a paper drive roll to be fixed inside the cover to position itself, when the printer is closed, the roll moves in a suitable roll housing seat that locks the paper drive roll so as to prevent the paper drive roll from getting out of the printer apparatus in case of accidental pushes.

The seat has a bottom wall which is positioned in the same direction of the closing apparatus both when the printer cover of the printer is opened and access to the printer is provided or when the printer cover is closed and when the printer cover is opened and is moved during operation in the roll rotation direction. This permits the cover to maintain the roll in a fixed position on the seat bottom due to the force exerted by the roll, during its rotation in a clockwise direction, which causes the creation of a downwards push which helps to block the paper drive roll in the roll housing seat. As the cover is closed or moved from its open position to its closed condition, the roll is moved from one end of the roll housing seat to the other end of the seat, so that when the cover is open, the roll may be rotated, and when the cover is closed the roll is locked in the seat.

When the cover is finally closed and in its closed condition, the printer is in standby condition and blockage of the printer is created, produced by the shape of the roll housing seat, that absolutely prevents the roll from exiting or going out from the seat and consequently, the roll housing seat and paper drive roll cooperate together to lock the printer cover to the chassis and prevent the printer cover from opening and exposing the printer.

The direction of movement of the paper drive roll in response to the direction of the moving force of the paper drive roll, which is parallel with the seat bottom, helps to generate a push that keeps the paper drive roll on the bottom and blocking it.

When the printing phase begins, the paper drive roll brings itself or moves itself into the printing position. In the printing position, a possible outside force (for example a printer falling, vibrations, pushes or other cause) can actuate the paper drive roll and, according to the invention, the paper drive roll and the bottom wall of the seat together oppose such outside force.

In the direction of opening or closing of the printer cover, the same seat wall for the paper roll. The moving force of the paper drive roll is parallel to the seat bottom wall, and the moving force of the paper drive roll generates a push that keeps the roll on the bottom wall of the seat and blocks the movement of the paper drive roll to prevent the cover from opening.

The last force to be generated by the rotation of the paper drive roll on itself keeps the cover locked.

Thermal rings are provided on a thermal print head. The paper on which printing is to take place is kept pressed between the thermal print head and the paper drive roll by the push actuated by the thermal rings of the thermal head on the paper.

The closing apparatus, is suitable for any kind of thermal printer with a fixed chassis portion.

### BRIEF DESCRIPTION OF THE DRAWINGS

FIG. 1 is a schematic showing of a thermal printer and a closing apparatus therefor, and shows a cover in an opening phase or position;

FIG. 2 is a schematic view or showing of the thermal printer showing the beginning of the closing phase with the printer head on its fulcrum and with the cover open and at the beginning of the closing phase;

FIG. 3 is a schematic view or showing of the printer in its closed phase with the cover in its completely closed condition on the printer chassis or closed phase and showing the paper drive roll into the seat and moving or going with the thermal rotating head on its fulcrum;

FIG. 4 is a schematic view or showing of the closed position of the cover on the thermal printer with the paper drive roll penetrating into the housing seat 4 and with the paper drive roll locked to the seat and the cover closed and the beginning of the printing phase of the thermal printing apparatus for the commencement of the printing phase and showing when the shaft of the printing roll moves from the position M in FIG. 6a to the position E in FIG. 6b with safety closing;

FIG. 5 is a partial schematic showing of the thermal head and the printing line shown in dashed horizontal line designated 6a, and with the printer and the cover in their closed condition.

FIGS. 6a and 6b show the steel shaft 3b on which the paper drive roll is carried and placed proximate to the housing seat 4 at the bottom shown at the left of level of horizontal wall 4a thereof and the cover 2 closed during the printing phase, when shaft 3b moves from position M at the left in FIG. 6a at the left side of the drawing to the position E at the right side in FIG. 6b to show a safety closing;

FIG. 7 is a schematic view of the different forces which act in the novel safety closing apparatus, and in particular show the steel shaft 3bwhich carries the paper drive roll 3 and extends through the drive roll 3 and extends outwardly from the paper drive roll 3 in the position M;

FIG. 8 is a view of a conventional thermal printer shown in an enclosure with cover 2 shown in full outline in its closed condition on chassis 1 and with the cover 2 open and shown in dashed outline; and

FIG. 9 shows the steel shaft 3b in three different positions as it moves during cover closing with respect to seat 4 and downwardly to the level wall 4a which forms the bottom or base of the housing seat for controlling the cover closing and prevent accidental pushes and vibrations, as well as an accidental opening of the cover which can damage the printer.

### Detailed Description of the Invention

Reference will now be made more particularly to the accompanying drawings which show the presently preferred mode for carrying out the invention.

The invention is a closure apparatus for a thermal printer to avoid damage to the printer due to an outside cause which may impart unwanted movement to the thermal printer.

The thermal printer includes a fixed chassis portion 1 and a cover 2 operatively associated with and coupled to chassis 1 for closure of the internal printing apparatus, as shown in the closed condition in full outline in FIG. 8 and with the cover 1 in its open condition shown in dashed outline. Cover 2 is hinged at one end by means of a hinged connection 20 to fixed chassis portion 1 which provides support for the printing apparatus as shown schematically.

Cover 2 includes a support mechanism 24 for supporting in a backlash way, a paper drive roll 3 for movement of a roll of paper 5 supported on a paper core member 22. Paper drive roll 3 comprises an outer rubber surface 3a and an inner steel shaft having a pair of opposite alternating outwardly from opposite ends 3b. Outside rubber 3a is molded onto the shaft 3b, and shaft has its opposite ends 3b which protrude from the outside rubber surface on both sides of the rubber surface.

Chassis 1 includes seat mechanism 4 associated with or forming part thereof, and cover 3 includes a support mechanism 24 coupled to or associated with cover 2 for carrying and supporting paper drive roll 3. Seat mechanism 4 and paper drive roll 3 cooperate together to form a locking mechanism to lock chassis 1 and cover 2 in their closed conditions.

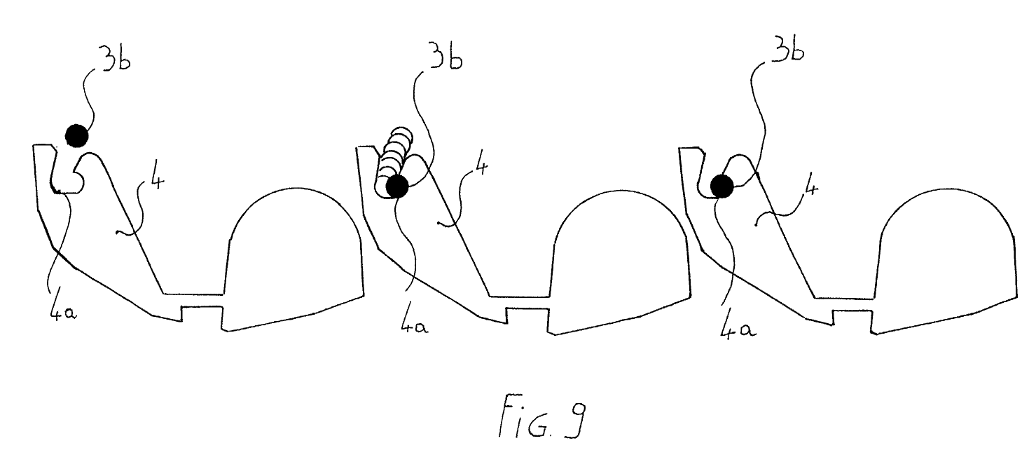

Chassis 1 is provided with housing seat 4 which has a bottom level wall 4a to receive the opposite ends 3b of the shaft, associated with cover 1, when shaft ends 3b move into housing seat 4 through opening 26 from its open cover position in FIG. 1 (and FIG. 9 dashed outline, to a beginning of closed cover position when the ends 3b of the shaft starts to enter a U-shaped opening 4U to move towards a bottom level wall 4a. As best seen in FIG. 7, the seat 4, including the U-shaped opening 4U with one end 3bof the steel shaft towards the right side of seat 4 resting on level wall 4a.

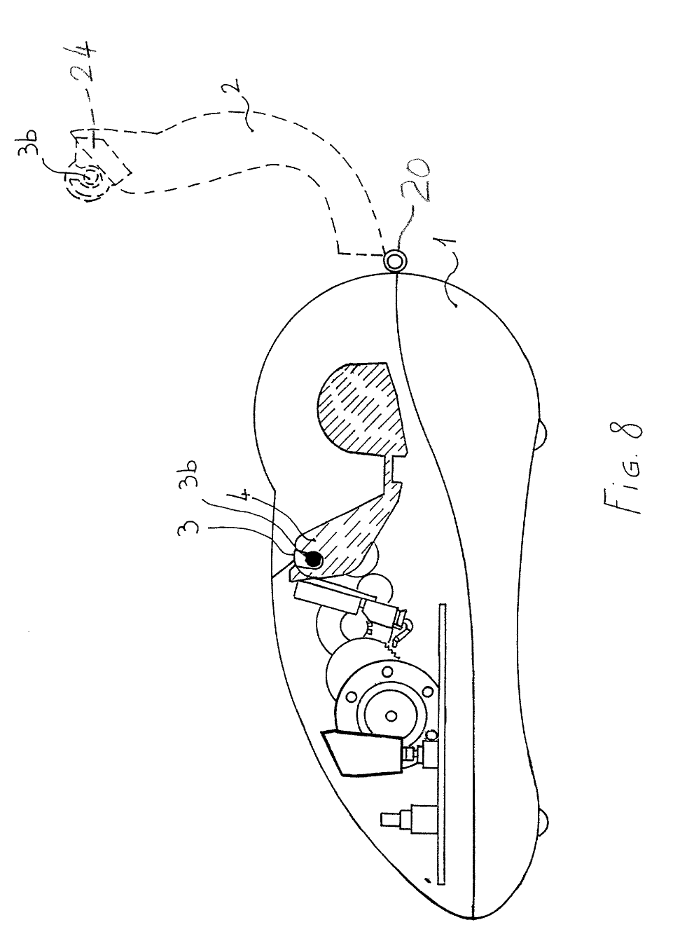

The end 3b enters into the U-shaped opening 4U when cover 2 is substantially closed and moves downwardly towards the left side and is seated onto level wall 4a of seat 4 in a fully closed condition and moves from the left side towards the right side to a fully closed and locked condition. Level wall 4a is parallel to the arrow N, and end 3b moves from position M in FIG. 6a to position E in FIG. 6b.

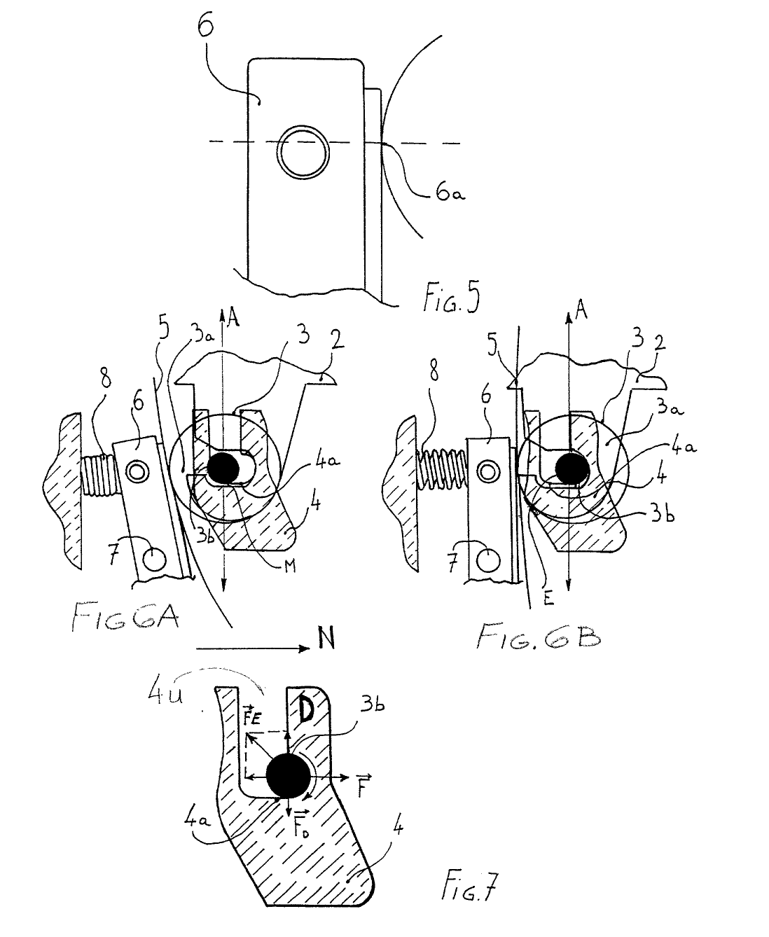

As shown in FIG. 5, printing head 6 with a printing line 6a forms part of the thermal printing apparatus and paper roll 5, carried on core member 22 which is to be printed does not adhere to the printing line 6a. Paper 5 as shown in FIGS. 1 to 4, is shown as a complete paper roll, rolled upon itself carried by the core member 22 or shaft which forms a central axle so as to be easily unrolled into sheet form for printing.

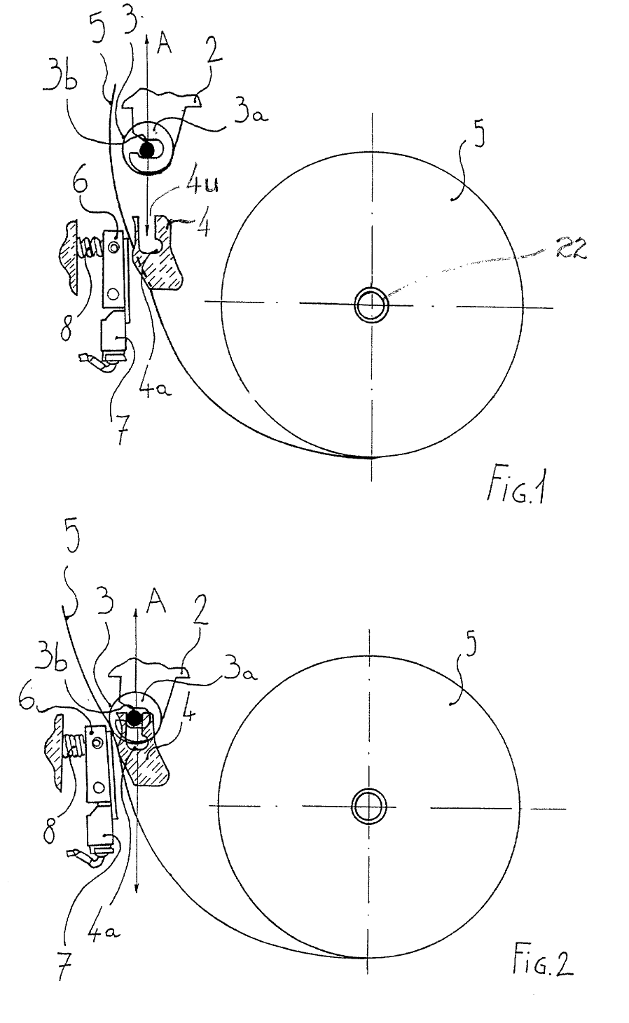

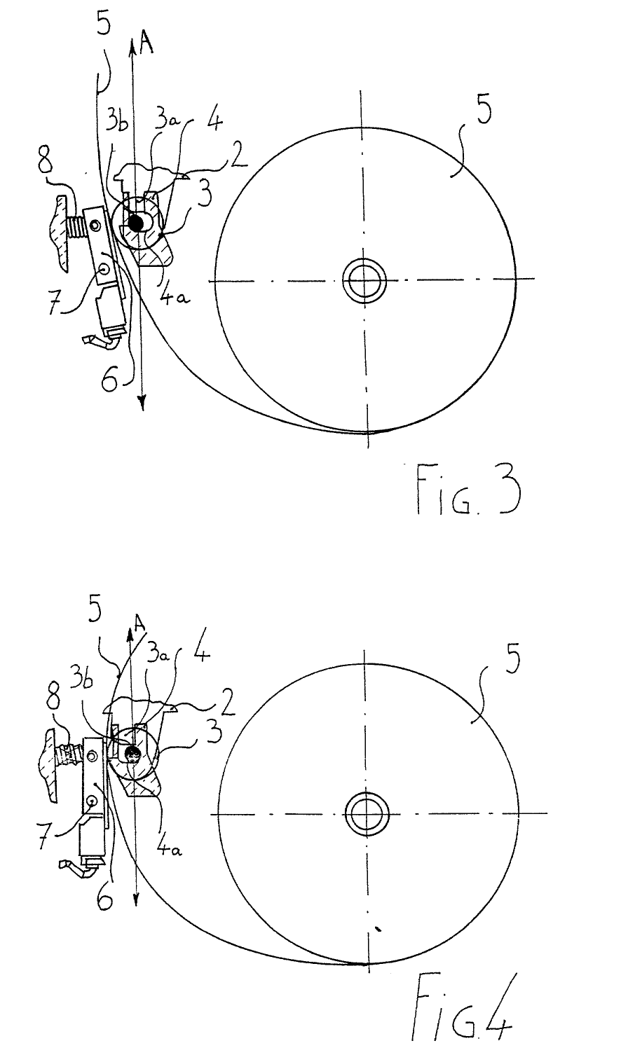

As noted heretofore, the closing phase begins in FIG. 2 and then continues in FIG. 3. In FIG. 2, as noted, the ends 3b of the steel shaft start to enter the housing seat through 4U in FIG. 2, and then on the left side at the bottom 4a in FIG. 3 and then to the right side in FIG. 4.

Thermal head 6 is provided for printing and is provided with a printing line 6a. Thermal head 6 is carried or supported for rotation on fulcrum 7. Springs 8 are provided to move the thermal head 6 about fulcrum 7 from the position in FIG. 1 towards paper drive roll 3 to the position shown in FIG. 2 with paper 5, held between thermal head 6 and seat 4.

### DESCRIPTION OF OPERATION

During the opening of the cover 2 (FIG. 1) the paper drive roll ends 3b is not in, but is outside of the housing seat 4 and is not in contact with bottom with level wall 4a. The paper 5 to be printed does not adhere to the printing line 6a of the thermal head 6. At the beginning the closing phase (FIG. 2 and FIG. 3), cover 2 and the end 3b of the steel shaft of the paper drive roll 3 enters through opening 4U and goes into the seat 4 and also causing the thermal head 6 to rotate on its fulcrum 7. With the cover definitively closed (FIG. 4) and with the thermal printer 1 in standby, ends 3b of paper drive roll 3 penetrates into the housing seat 4 and reaches the bottom on level wall 4a, thermal head 6 rotates from the lowering of the roll 3 on its fulcrum 7 and is pushed by the springs 8, to press the paper 5 between the paper drive roll 3 and the thermal head 6 as seen in FIG. 6a and then the ends 3b move from the left side to the right side of seat 4 as thermal head 6 moves about fulcrum 7 and rotates in a clockwise direction towards the right as shown in FIG. 6b.

Beginning with the printing phase (FIG. 4) the paper drive roll 3 begins to rotate keeping itself in the printing position E, (FIG. 6b) with the seat 4 and placed into operation by the rotation of the paper drive roll 3. In this printing position E a possible outside force FE (see FIG. 7) to be made on the paper drive roll 3 by an eventual falling or by possible vibrations or pushes is opposed. In the direction A of opening/closing of the cover 2, to the wall D (see FIG. 7) the seat 4 and the cooperation of and the paper drive roll 3 in the direction N parallel to the bottom 4a of the seat 4, in response to the force F (FIG. 7), the moving force of the paper drive roll 3 parallel to the bottom 4a of the roll housing 4. With the cover 2 locked to chassis 1 and the thermal head 6 and paper drive roll 3, the paper 5 is held between them for printing.

The moving force F of the paper drive roll is generated by the rotation of the paper drive roll 3 on itself. The paper 5 is kept compressed between the thermal head 6 and the paper drive roll 3, when this last one is in the printing position E, by the push actuated by the springs 8 on the same thermal head 6.

The various steps of the closing apparatus and working phases are illustrated in FIGS. 1 to 4, and show the various phases of opening and closing of the cover and the printing phase.

FIGS. 5 to 7 illustrate the housing seat 4 with its bottom 4a. FIG. 1 shows the cover 2 in its opening phase.

FIG. 2 shows the cover 2 at the beginning of the closing phase. FIG. 3 shows the cover definitively, closed.

FIG. 4 shows the closed cover with the beginning of the printing phase.

FIG. 6 shows the steel shaft 3b placed at the bottom 4a of the housing seat 4 with the cover definitively closed and during the printing phase when the shaft moves from the position M to the position E with safety closing.

The schematic view of the different forces which act in the invented safety closing apparatus are shown in FIG. 7.

FIG. 8 is a view of any suitable openable thermal printer 1 with its cover 2 closed/opened.

FIG. 9 is an essential scheme to point out the position of the steel shaft 3b on the bottom 4a of the housing seat so to disclose a cover closing against accidental pushes and vibrations and to show the cover in its open and closed conditions.

While there has been shown and described, what is considered to be the presently preferred mode for carrying out the present invention, various changes and modifications may be made without departing from the scope of the invention.

1. A thermal printer closing apparatus, for a thermal printer provided with a fixed chassis portion (1), and a cover (2) therefore, the chassis supporting in a backlash manner a thermal printer apparatus inside the chassis portion and the cover in its closed condition and a paper drive roll having an outside rubber surface (3a) and an inside steel shaft ends (3b), the rubber surface being molded on said steel shaft, and said shaft has ends protruding on the two sides of the rubber surface, and the thermal printer includes a printing phase and a closing phase, and the closing apparatus comprises:
a housing seat (4) associated with said chassis for the steel shaft, said housing seat having a bottom with a level wall (4a); and the closing phase includes;
said cover including said steel shaft ends associated therewith; means for closing the cover at the beginning of the closing phase of the cover (2) including means for moving the steel shaft ends (3b) and the paper drive roll (3) for movement of the steel shaft into the seat (4) and causing the thermal head (6) to rotate on a fulcrum (7) while the cover is closed and with the thermal printer (1) moved into its stand-by condition, the paper drive roll (3) is caused to penetrate into the housing seat (4), and the thermal head (6) rotates on its fulcrum (7) from a position lowering of the roll (3) and being pushed by the springs (8), for pressing the paper (5) between the paper drive roll (3) and the thermal head; and
during the printing phase the paper drive roll (3) begins to rotate keeping itself in a printing position E, being the seat (4) planed in operation of the rotation way of the paper drive roll (3).

2. The thermal printer closing apparatus, as claimed in 1, including:
means, when the printing apparatus is in the printing position E, a possible outside force FE may be caused to act on the paper drive roll (3) by an eventual falling, vibrations or pushes and is opposed, in a first direction of opening/closing of the cover (2),towards a wall of the seat (4) of the roll and,
in a direction towards the first direction parallel to the bottom (4a) having a level wall of the seat (4), to a force generated by the rotation of the paper drive roll (3) on itself, and
means for keeping the paper (5) compressed between the thermal head (6) and the paper drive roll (3), when this last one is in the printing position E, by the push actuated by the springs (8) on the same thermal head (6).

3. In a thermal printer apparatus, a safety closure for maintaining closure of a cover on a chassis containing the printer apparatus, the printer apparatus including a paper drive roll for rotating a printing paper roll and including a steel shaft and an outside rubber surface on said steel shaft, said steel shaft having its opposite ends extending outside and beyond said rubber surface, said printing apparatus being fixed to said chassis, and a cover movably connected with said chassis for movement from an open position to provide access to said printing apparatus to a closed position to prevent access to said printing apparatus, said safety closure including:
a housing seat associated with said chassis having a level wall;
a paper drive roll coupled to said cover, said paper drive roll having said opposite ends extending from said rubber surface; and
locking means for locking said cover to said chassis;
said locking means including an entry to said housing seat for receiving said opposite ends of said steel shaft and holding said ends in said housing seat and locking said cover to said chassis.

4. In the thermal printer as claimed in claim 4, wherein said housing seat includes a U-shaped portion for providing an entry to said housing seat, for receiving said ends of the steel rod.

5. In the thermal printer as claimed in claim 4, wherein said housing seat includes a U-shaped member having a pair of opposed walls forming an entry and a base joining said opposed walls forming the bottom housing seat.

6. In the thermal printer as claimed in claim 5, wherein said thermal printer includes a pivotal printing head pivotal on a fulcrum, and said printing head and housing seat hold paper to be printed thereon as the printing head is moved towards the housing seat by springs associated with said printing head.

7. In the thermal printer as claimed in claim 4, wherein said housing seat includes a U-shaped portion having a base portion and a pair of spaced sides for providing an entry to said housing seat, for receiving said ends of the steel rod.

8. In the thermal printer as claim in claim 4, wherein said housing seat includes a U-shaped member having a base portion and a pair of spaced opposed walls forming an entry to said base portion joining said opposed walls and forming the bottom housing seat.

9. In the thermal printer as claimed in claim 8, wherein said thermal printer includes a pivotal printing head pivotal on a fulcrum, means for pivoting said printing head towards said printing head, said printing head and housing seat hold paper to be printed thereon as the printing head is moved towards the housing seat by said pivoting means.

10. In a thermal printer apparatus, a safety closure for maintaining closure of a cover on a chassis containing the printer apparatus, the printer apparatus including a paper drive roll for carrying printing paper, and said paper drive roll including a shaft and an outside rubber surface on said shaft, said printing apparatus being fixed to said chassis, and a cover movably connected with said chassis for movement from an open position to provide access to said printing apparatus to a closed position to prevent access to said printing apparatus, said safety closure including:
a housing seat associated with said chassis
means for locking said cover to said chassis, including:
said paper drive roll being coupled to said cover, said shaft having its opposite ends extending outside of and beyond said rubber surface; and said housing seat including an entry to said housing seat for receiving at least one of said opposite ends for locking said paper drive roll and said housing seat for locking said cover and said chassis together.

11. In the thermal printer apparatus as claimed in claim 10, wherein said housing seat includes a level wall.

12. In the thermal printer apparatus as claimed in claim 10, including a thermal head, wherein said thermal head, said housing seat and said paper drive roll cooperate to lock said chassis and said cover and to hold paper to be printed thereon together between said paper drive roll and said thermal printer, and means for urging said thermal printer and said paper drive roll together to hold the paper there between.

13. In the thermal printer apparatus as claimed in claim 12, wherein said seat includes a horizontal surface having a U-shaped entry portion for receiving the ends of said shaft ends as said thermal head moves towards said paper drive roll.

14. In the thermal printer apparatus as claimed in claim 13, including springs for moving said thermal print head into engagement with said paper drive roll as said shaft end moves into locking engagement with said seat for holding the paper in its printing position and locking said cover and chassis together.
